(19) United States
(12) Patent Application Publication
(10) Pub. No.: US 2011/0089678 A1
(43) Pub. Date: Apr. 21, 2011

(54) LAMINATED LOTTERY TICKET CONSTRUCTION

(76) Inventors: Michael John Brickwood, Winnipeg (CA); Blaine Reimer, Winnipeg (CA); Angela Johnson, Winnipeg (CA)

(21) Appl. No.: 12/580,766

(22) Filed: Oct. 16, 2009

(51) Int. Cl. B42D 15/00

(52) U.S. Cl. 283/94; 283/102

(57) ABSTRACT

A lottery ticket is printed onto two substrate sheets where the sheets are laminated together with both of equal length and with the top sheet approximately half the width of the bottom sheet and arranged along one side edge of the bottom sheet leaving approximately half of the bottom sheet exposed and free to fold over the top sheet. A series of break open windows is provided in the front surface of the top sheet which can be opened by a player to expose some of the game indicia printed onto the front face of the bottom sheet and covered also by a layer of scratchoff. Some of the game indicia is located on the front surface of the bottom sheet and is covered by a layer of scratchoff material so that it is on the inside when the bottom sheet is folded over.

The present invention relates generally to the field of game or lottery tickets and more particularly to a combined ticket assembly which is formed of two laminated sheets.

### BACKGROUND OF THE INVENTION

Lottery tickets are well known and widely sold and typically comprised of a sheet material of paper or card stock on which is printed lottery information and various indicia for the playing of one or more games. Many such games are instant win type games where the player can play the game or games by carrying out various functions, for example, scratching a scratch-off covering layer, opening pull tabs on a break-open ticket. Such tickets are also known variously as pull-tabs, pickle cards, jar tickets, hard cards and charitable gaming tickets.

Break-open tickets are typically constructed by printing a sheet containing multiple combinations of lottery indicia thereon. This sheet is then cut into sections. The opposite side of this sheet includes prize categories, serial number etc. A second sheet which contains removable tabs or break-open windows is then mounted onto the card stock such that the break-open windows overlap the lottery indicia. However, break-opens prepared in this manner have the disadvantages that they are cumbersome to prepare, have a limited set of winning symbols and require manually checking at the time of redemption.

Typically simple lottery tickets are printed on a single substrate sheet and the game data are covered by a layer of a scratchoff material which can be removed to expose the game data to reveal the ticket as a winning or losing ticket.

U.S. Pat. No. 4,174,857 (Koza) and U.S. Pat. No. 5,253,899 (Greenwood) each disclose a combined ticket construction in which a second layer is applied or folded over the basic ticket to improve security.

U.S. Pat. No. 5,562,284 (Stevens) issued Oct. 8, 1996 discloses a break-open ticket with a second level of break-open underneath the first level.

U.S. Pat. No. 5,217,258 (Sanderson) issued Jun. 8, 1993 discloses a two sided break-open ticket where the windows are arranged back to back opening onto a single center sheet carrying the game data.

U.S. Pat. No. 6,234,477 (Scrymgeour) assigned to the present assignee and issued May 22, 2001 discloses a construction of lottery ticket which utilizes variable image printing techniques in combination with lamination of two substrate sheets together to form what is initially a common pouch construction with the game indicia on the inside surface where the sheets can be separated, each from the other, to form in effect two separate tickets.

U.S. Pat. No. 6,347,794 (Scrymgeour) assigned to the present assignee and issued Feb. 19, 2002 discloses a similar construction of lottery ticket which utilizes variable image printing techniques in combination with lamination of two substrate sheets together to form a ticket which carries both game data covered by a scratchoff layer on one side and game data covered by break-open windows on the other side.

U.S. Pat. No. 6,145,885 (Scrymgeour) assigned to the present assignee and issued Nov. 14, 2000 discloses a similar construction of lottery ticket which utilizes variable image printing techniques in combination with lamination of two substrate sheets together to form a ticket with break open windows where the data is printed by variable image techniques on the substrate rather than by the technique described above.

Canadian Patent No. 2,359,581 (Scrymgeour) assigned to the present assignee and published Jan. 26, 2002 discloses a similar construction of lottery ticket which utilizes variable image printing techniques in combination with lamination of two substrate sheets together to form a ticket which has break open windows on a front face where the game data exposed underneath the windows is also covered by a scratchoff layer.

US Published Patent Application No. 2004/0188997 (Scrymgeour) assigned to the present assignee and published Sep. 30, 2004 discloses a further similar construction of lottery ticket which utilizes variable image printing techniques in combination with lamination of two substrate sheets together to form a ticket where outside edges on three sides can be torn away to allow the two sheets to be opened up to expose an interior surface of double area which can carry scratchoff games of more complexity.

U.S. Pat. No. 7,472,926 (Friesen) assigned to the present assignee and issued Jan. 6, 2009 discloses a further similar construction of lottery ticket which utilizes variable image printing techniques in combination with lamination of two substrate sheets together to form a booklet of scratchoff games with four pages and eight sides available to receive the games.

### SUMMARY OF THE INVENTION

It is one object of the present invention to provide a lottery ticket construction uses the above techniques of variable image printing in combination with lamination of two substrate sheets to form a novel unique construction attractive to the purchasing public.

According to a first aspect of the invention there is provided a game ticket construction comprising:

substrate sheet material;

promotional graphics printed on the substrate sheet material;

game information printed on the substrate sheet material;

and game indicia printed by variable image printing onto the substrate sheet material;

the substrate sheet material comprising:

a first substrate sheet having a front surface and a rear surface;

a second substrate sheet having a front surface and a rear surface;

the first and second substrate sheets being of equal dimension in a first direction of the game ticket construction;

the first substrate sheet being smaller in a second direction at right angles to the first direction than the second substrate sheet;

the first substrate sheet being arranged with the rear surface thereof overlying the front surface of the second substrate sheet;

the rear surface of the first substrate sheet being attached to the front surface of the second substrate sheet at least around side edges of the rear surface of the first substrate sheet;

such that the first substrate sheet covers a part only of the first surface of the second substrate sheet to form a part of the game ticket construction which has a double thickness of the substrate sheet material;

and such that the first substrate sheet leaves at least one exposed part of the first surface of the second substrate sheet which is exposed;

a plurality of break open windows provided in one part of the substrate sheet material at the double thickness part which can be opened by a player to expose at least part of the game indicia.

Preferably the double thickness part is arranged at a first side edge of the second substrate sheet with a single exposed part therefore along the second side edge. However it is also possible to provide the double thickness portion at the first sheet at a position spaced from both edges leaving an exposed part of the second sheet along both edges. This can be in the middle or offset to one side.

Preferably the double thickness part and the exposed part are of equal or approximately equal width. However this is not necessarily so and one may be wider than the other depending upon the preferred relative sizes of the two areas to be formed.

Preferably the exposed part, or parts if there is more than one, is folded over the double thickness part along a fold line to form a folded card where the first sheet forms the front face of the back part and the second sheet forms a front part. In this case, the fold line can be arranged at a junction between the double thickness part and the exposed part, although this is not necessarily so and the fold line can be at any location on the second sheet in the single thickness part.

Preferably, in the folded card construction defined above, each part of the rear surface of the second substrate sheet which forms the front and rear respectively of the card is free from game indicia. In this way the construction has the appearance of a greetings card with the game data wholly on the inside surfaces. However game data with a covering of a scratchoff layer can be applied on the rear or outer surfaces of the second sheet or on the first sheet as required.

For production, shipping and dispensing, preferably the first and second substrate sheets are supplied in an initial condition in a flat unfolded condition.

Preferably there are a series of break open windows which are located in the front surface of the first substrate sheet that is the inside surface of the above card type construction.

Preferably the game indicia under the one break open window or windows is also covered by a layer of a scratchoff material to enhance the game playing action.

Preferably the first and second substrate sheets are rectangular. However other shapes are also possible

Preferably there are only two sheets. That is construction is formed only from the two overlying sheets. However additional sheets can be provided either as a further narrow sheet applied onto the second sheet as a band spaced from the first sheet or as a third layer behind the second sheet.

Preferably the game data are arranged to provide an instant win lottery game to be played by the player where the result of whether the lottery game is a winning or losing lottery game is predetermined. However the game data may be of a character which does not have any prize and may be for promotional or merely entertainment value. Probability games where the result is determined by the playing action can also be provided using this arrangement.

Typically at least one of the sheets will have printed thereon a bar code arranged for validating when the game indicia.

Preferably the construction is formed in a row of the tickets with junctions between each and the next arranged at right angles to the first direction.

According to a second aspect of the invention there is provided a game ticket construction comprising:

substrate sheet material;

promotional graphics printed on the substrate sheet material;

game information printed on the substrate sheet material;

and game indicia printed by variable image printing onto the substrate sheet material;

the substrate sheet material comprising:

a first substrate sheet having a front surface and a rear surface;

a second substrate sheet having a front surface and a rear surface;

the first and second substrate sheets being of equal dimension in a first direction of the game ticket construction;

the first substrate sheet being smaller in a second direction at right angles to the first direction than the second substrate sheet;

the first substrate sheet being arranged with the rear surface thereof overlying the front surface of the second substrate sheet;

the rear surface of the first substrate sheet being attached to the front surface of the second substrate sheet at least around side edges of the rear surface of the first substrate sheet;

such that the first substrate sheet covers a part only of the first surface of the second substrate sheet to form a double thickness part of the game ticket construction which has a double thickness of the substrate sheet material;

and such that the first substrate sheet leaves at least one exposed part of the first surface of the second substrate sheet which is exposed;

wherein the double thickness part is arranged at a first side edge of the second substrate sheet with said exposed part along a second side edge;

wherein said at least one exposed part is arranged to be folded over the double thickness part along a fold line;

a plurality of break open windows provided in the front surface of the first substrate sheet so as to be located at the double thickness part, which can be opened by a player to expose some of the game indicia;

and some of the game indicia being located on the front surface of the second substrate sheet and covered by a layer of scratchoff material.

### BRIEF DESCRIPTION OF THE DRAWINGS

One embodiment of the invention will now be described in conjunction with the accompanying drawings in which:

FIG. 1 is a front elevational view of a game ticket according to the present invention.

FIG. 2 is a cross sectional view along the lines 2-2 of FIG. 1.

FIG. 3 is a cross sectional view along the lines 3-3 of FIG. 1.

In the drawings like characters of reference indicate corresponding parts in the different figures.

### DETAILED DESCRIPTION

The ticket construction shown in the figures comprises a first substrate sheet 10 and a second substrate sheet 11 with the first sheet 10 overlying the second sheet 11. In the example shown the co-substrate sheets are rectangular. The sheets 10 and 11 are co-extensive in the longitudinal direction L so that the side edges 10A and 10B directly overlie the side edges 11A and 11B.

The substrate sheet 10 is however narrower than the sheet 11 in the width direction W so that it has an edge 10C part way across the sheet 11 and thus spaced from the edge 11C of the sheet 11.

In the example shown the sheet 10 is half the width of the sheet 11 so that an exposed part 11E of the sheet 11 defining a single thickness part 12 of the ticket construction is of equal width to a double thickness part 13 of the ticket construction. The sheet 10 is laid at the side edge 11D of the sheet 11 so that the edges 10D and 11D are directly overlying.

A layer 16 of an adhesive material is located between the two substrate sheets and acts to laminate the sheets together substantially over the whole area of the sheet 10 and particularly at the side edges 10A, 10B, 10C and 10D. The substrate sheets are however unconnected at other areas outside the layer of adhesive 16.

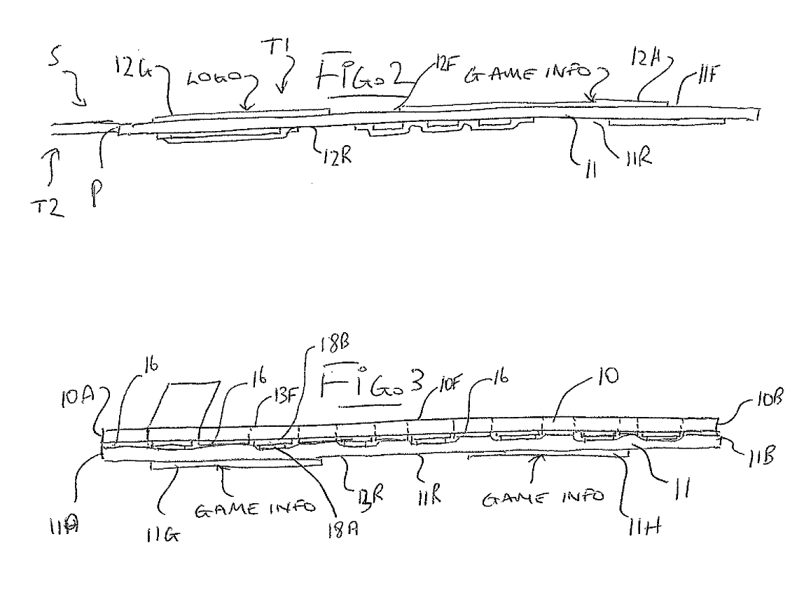

The substrate sheets are supplied in a flat condition. The adhesive layer is thin so that it allows the substrate sheets to lie directly on top of one another. Thus in the flat condition, the substrate sheets form in effect a single ticket construction defined by two laminated sheets 10 and 11 allowing the ticket to be handled and supplied in the flat condition. The two substrate sheets form part of a continuous strip S of the substrate sheets separated at transverse perforation lines P so as to form, as shown in FIG. 2, a first ticket construction T1 followed by a second ticket construction T2 divided by the perforation line P. The ticket constructions, as is conventional, can be supplied in fan-folded condition with the folds being located at the perforation lines P. The fact that the ticket is formed by two overlying sheets does not interfere with the fan folding action or the supply of the tickets using conventional dispensing systems. The ticket may be wider than many conventional tickets but it will be appreciated that conventional tickets vary in width of a large range.

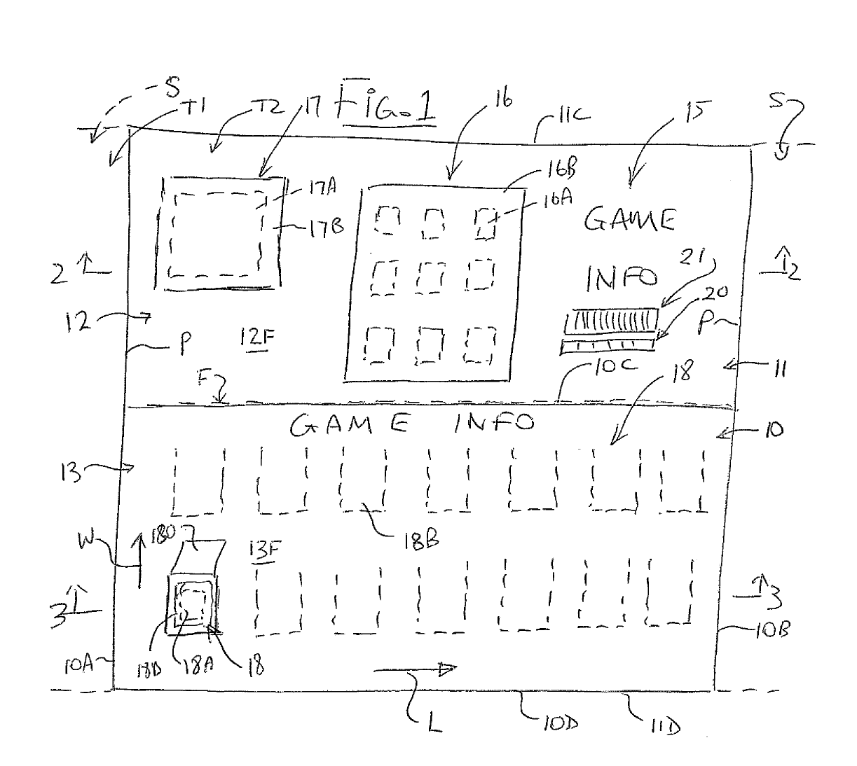

The complete construction as shown in FIG. 1 therefore provides two separate sheet parts 12 and 13 each of which has two surfaces defined by a rear surface 12R, 13R and a front surface 12F and 12F. The rear surfaces 12R, 13R are provided by the rear surface of the sheet 11 as indicated at 11R. The front surface 12F is provided by exposed portion of the front surface 11F of the sheet 11. The front surface 13F is provided by the front surface 10F of the sheet 10.

As shown in FIG. 1, the flat construction can be folded into a folded condition along a centre line F by folding at the edge 10C of the sheet 10. This acts to form the ticket construction into the arrangement of a typical greeting card with a front sheet and a rear sheet.

Prior to the assembly of substrate sheets into the flat condition shown in FIG. 1, the sheets are printed with the necessary game information and game indicia for the playing of games printed onto the selected surfaces of the sheet parts. Thus as shown in the figures, the front sheet 12F carries game information 15, a first game 16 and a second game 17. Each of the games 16 and 17 includes game data 16A, 17A covered by a layer of scratchoff material 16B, 17B. The game 16 includes a series of different game data elements which can be compared to determine a winning or losing game. The game 17 includes a single game data element which can be compared to required game data set out in the game information 15 to determine a winning or losing game. The rear surface 12R and 13R of the game card contain only game information 11G and 11H and 12G and 12H and no game indicia where the game indicia are covered by a scratch-off coating 42. Thus the exterior of the card construction contains no game but only initial game information again in the format of a greetings card.

The game information provides data relating to the game for the player. The game indicia provides actual playing game indicia by which the player can play the particular game using the game information as rules or other data necessary for the playing of the game. Many different types of games can be formed using this construction of game information and game indicia together with the scratch-off coating as is well known to one skilled in the art.

The front surface 13F contains a game 18 defined by a series of break open windows 18B which can be opened as indicated at 180 to expose game data 18A which may be covered by an optional layer of scratchoff material 18B or may be exposed directly by opening the break-open window.

Thus the construction provides in ticket which has the appearance to the player of a greetings card containing both scratchoff and break open type games. The theme of the card can be varied in accordance with the intentions of the game designer so that all of the games have some connected theme. Some of the games can be connected one with the next to provide in effect a common game. Alternatively each of the individual games on each of the surfaces may be separate from the others.

In FIG. 1, there is shown a printed validation number 20 and a bar code 21 which can be used for validating the ticket construction. In the example shown there is only one validation number and one bar code for the whole of the ticket construction but it will be appreciated that each individual ticket part may have its own individual bar code and validation number for the purposes of validating that particular element, should the player or the lottery require that one particular part or one of the substrate sheets be separated along the fold line F if that part is a winning ticket element.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A game ticket construction comprising:
substrate sheet material;
promotional graphics printed on the substrate sheet material;
game information printed on the substrate sheet material;
and game indicia printed by variable image printing onto the substrate sheet material;
the substrate sheet material comprising:
a first substrate sheet having a front surface and a rear surface;
a second substrate sheet having a front surface and a rear surface;
the first and second substrate sheets being of equal dimension in a first direction of the game ticket construction;
the first substrate sheet being smaller in a second direction at right angles to the first direction than the second substrate sheet;
the first substrate sheet being arranged with the rear surface thereof overlying the front surface of the second substrate sheet;
the rear surface of the first substrate sheet being attached to the front surface of the second substrate sheet at least around side edges of the rear surface of the first substrate sheet;
such that the first substrate sheet covers a part only of the first surface of the second substrate sheet to form a part of the game ticket construction which has a double thickness of the substrate sheet material;
and such that the first substrate sheet leaves at least one exposed part of the first surface of the second substrate sheet which is exposed;
a plurality of break open windows provided in one part of the substrate sheet material at the double thickness part which can be opened by a player to expose at least part of the game indicia.

2. The construction according to claim 1 wherein the double thickness part is arranged at a first side edge of the second substrate sheet with said exposed part along a second side edge.

3. The construction according to claim 2 wherein the double thickness part and the exposed part are of equal width.

4. The construction according to claim 1 wherein said at least one exposed part is folded over the double thickness part along a fold line.

5. The construction according to claim 4 wherein the fold line is arranged at a junction between the double thickness part and the exposed part.

6. The construction according to claim 4 wherein each part of the rear surface of the second substrate sheet which forms the front and rear respectively of the game ticket construction when folded is free from game indicia.

7. The construction according to claim 4 wherein the first and second substrate sheets are supplied in an initial condition for dispensing in a flat unfolded condition.

8. The construction according to claim 1 wherein there is provided at least some of the game indicia on the second substrate sheet which game indicia is covered by a layer of scratchoff material.

9. The construction according to claim 1 wherein said at least one break open window is located in the front surface of the first substrate sheet.

10. The construction according to claim 1 wherein there is provided at least some of the game indicia on the exposed part of the front surface of the second substrate sheet which game indicia is covered by a layer of scratchoff material.

11. The construction according to claim 1 wherein at least some of the game indicia under said at least one break open window is covered by a layer of a scratchoff material.

12. The construction according to claim 1 wherein the first and second substrate sheets are rectangular.

14. The construction according to claim 1 wherein there are only two sheets.

15. The construction according to claim 1 wherein at least some of the game indicia are arranged relative to the game information to provide an instant win lottery game to be played by the player where the result of whether the lottery game is a winning or losing lottery game is predetermined and wherein at least one of the sheets has printed thereon a bar code arranged for validating when the game indicia relate to a winning lottery game.

16. The construction according to claim 1 wherein there are provided a series of the game ticket constructions arranged in a row with junctions between each and the next arranged at right angles to the first direction.

17. A game ticket construction comprising:
substrate sheet material;
promotional graphics printed on the substrate sheet material;
game information printed on the substrate sheet material;
and game indicia printed by variable image printing onto the substrate sheet material;
the substrate sheet material comprising:
a first substrate sheet having a front surface and a rear surface;
a second substrate sheet having a front surface and a rear surface;
the first and second substrate sheets being of equal dimension in a first direction of the game ticket construction;
the first substrate sheet being smaller in a second direction at right angles to the first direction than the second substrate sheet;
the first substrate sheet being arranged with the rear surface thereof overlying the front surface of the second substrate sheet;
the rear surface of the first substrate sheet being attached to the front surface of the second substrate sheet at least around side edges of the rear surface of the first substrate sheet;
such that the first substrate sheet covers a part only of the first surface of the second substrate sheet to form a double thickness part of the game ticket construction which has a double thickness of the substrate sheet material;
and such that the first substrate sheet leaves at least one exposed part of the first surface of the second substrate sheet which is exposed;
wherein the double thickness part is arranged at a first side edge of the second substrate sheet with said exposed part along a second side edge;
wherein said at least one exposed part is arranged to be folded over the double thickness part along a fold line;
a plurality of break open windows provided in the front surface of the first substrate sheet so as to be located at the double thickness part, which can be opened by a player to expose some of the game indicia;
and some of the game indicia being located on the front surface of the second substrate sheet and covered by a layer of scratchoff material.

18. The construction according to claim 17 wherein the double thickness part and the exposed part are of equal width.

19. The construction according to claim 17 wherein the fold line is arranged at a junction between the double thickness part and the exposed part.

20. The construction according to claim 17 wherein each part of the rear surface of the second substrate sheet which forms the front and rear respectively of the game ticket construction when folded is free from game indicia.

21. The construction according to claim 17 wherein at least some of the game indicia under said at least one break open window is covered by a layer of a scratchoff material.
